(19) United States
(12) Patent Application Publication
(10) Pub. No.: US 2025/0326304 A1
(43) Pub. Date: Oct. 23, 2025

(54) STATIONARY BATTERY ELECTRIC VEHICLE CHARGERS WITH ENHANCED POWER MODULES

(71) Applicant: BorgWarner Inc., Auburn Hills, MI (US)

(72) Inventors: Luca Di Carlo, Royal Oak, MI (US); Brian C. Wightman, Davisburg, MI (US)

(21) Appl. No.: 18/638,776

(22) Filed: Apr. 18, 2024

(51) Int. Cl. B60L 53/10; B60L 53/18

(52) U.S. Cl. CPC B60L 53/11; B60L 53/18; B60L 2210/10; B60L 2210/30

(57) ABSTRACT

A stationary battery charger, configured to detachable couple with and charge a battery electric vehicle (BEV) battery, including an input for receiving alternating current (AC) voltage from an electrical grid; one or more electrical cables configured to detachably couple with BEVs; and one or more enhanced power modules, electrically coupled to the input, that convert AC voltage to direct current (DC) voltage, each comprising a low voltage output for powering auxiliary circuits within the stationary battery charger and a high voltage output for applying DC voltage to the BEV battery.

### TECHNICAL FIELD

The present application relates to battery electric vehicle (BEV) charging and, more particularly, to stationary charging stations used to charge BEVs.

### BACKGROUND

Battery electric vehicles (BEVs) occupy an increasing share of the vehicles purchased by consumers. The BEVs are often electrically connected to a residential battery charger at a residence where the consumer lives. However, as the quantity of BEVs increases, so too will an electrical infrastructure that will be available to charge the BEVs away from a residence or home location. Governmental entities and publicly accessible businesses or workplaces will increasingly offer a stationary charging station that will be available to charge electrically couple to a BEV and charge vehicle batteries included on the BEVs away from an owner's residence. Currently, the components included in a stationary charging station and assembly of those components involves significant expense. It would be helpful to reduce the number of components included in the stationary charging station.

### SUMMARY

In one implementation, a stationary battery charger, configured to detachable couple with and charge a battery electric vehicle (BEV) battery, including an input for receiving alternating current (AC) voltage from an electrical grid; one or more electrical cables configured to detachably couple with BEVs; and one or more enhanced power modules, electrically coupled to the input, that convert AC voltage to direct current (DC) voltage, each comprising a low voltage output for powering auxiliary circuits within the stationary battery charger and a high voltage output for applying DC voltage to the BEV battery.

In another implementation, a stationary battery charger, configured to detachable couple with and charge a BEV battery, includes an input for receiving AC voltage from an electrical grid; one or more electrical cables configured to detachably couple with BEVs; one or more enhanced power modules, electrically coupled to the input, that convert AC voltage to DC voltage, each including a switched mode power supply (SMPS) coupled to a low voltage output for powering auxiliary circuits within the stationary battery charger; a power factor correction (PFC) module that rectifies AC voltage received from the grid into DC voltage supplied to the SMPS and the one or more electrical cables; and a control system, electrically connected to the SMPS that controls the SMPS and the PFC module.

In yet another implementation, a stationary battery charger, configured to detachable couple with and charge a BEV battery, including an input for receiving AC voltage from an electrical grid; one or more electrical cables configured to detachably couple with BEVs; one or more enhanced power modules, electrically coupled to the input, that convert AC voltage to DC voltage, each including a switched mode power supply (SMPS) coupled to a low voltage output for powering auxiliary circuits within the stationary battery charger; a power factor correction (PFC) module that rectifies AC voltage received from the grid into DC voltage supplied to the SMPS and the one or more electrical cables; an isolation monitoring device (IMD) electrically coupled to the one or more electrical cables; and a control system, electrically connected to the SMPS that controls the SMPS, the IMD, and the PFC module.

### BRIEF DESCRIPTION OF THE DRAWINGS

FIG. 1 is a block diagram depicting an implementation of an electrical system including a battery electric vehicle (BEV) and a stationary vehicle charger;

FIG. 2 is a block diagram depicting an implementation of a stationary vehicle charger; and

FIG. 3 is a block diagram depicting an implementation of an enhanced power module included in a stationary vehicle charger.

### DETAILED DESCRIPTION

A stationary battery charger is capable of electrically coupling to a battery electric vehicle (BEV) and may simultaneously charge a plurality of BEVs. The stationary battery charger can receive alternating current (AC) electrical power from an electrical grid, convert the AC electrical power into direct current (DC) electrical power, and then supply the DC electrical power directly to a vehicle battery on the BEV. Charging more than one BEV at the same time can involve the receipt of significant levels of AC electrical power from the electrical grid. The conversion of the AC electrical power received from an electrical grid to DC electrical power suitable for application to the vehicle battery can be carried out using power modules that are electrically connected to separate, complex, and expensive auxiliary circuits that carry out other functionality of the stationary battery charger. For example, a stationary battery charger can include separate power modules for each BEV that are electrically connected to a separate auxiliary circuits in the form of a user interface, a control system, a cooling system, insulation monitoring devices (IMDs) electrically connected between each BEV and each power module, a separate switched mode power supply (SMPS) for powering the auxiliary circuits, and/or electrical contactors (switches) that regulate the flow of electrical current within the charger.

In contrast, the stationary battery charger disclosed here can include a plurality of enhanced power modules, each configured to incorporate at least some of the functionality provided by the separate auxiliary circuits discussed above. The enhanced power modules can integrate functionality carried out by the auxiliary circuits along with AC/DC electrical power conversion. In one implementation, the enhanced power module(s) can provide an output voltage, such as that provided by the SMPS, to the UI, cooling system, and/or the control system. In addition, the enhanced power modules can each include resident IMD functionality. Stationary battery chargers including enhanced power modules can be configured with fewer electrical components by eliminating at least some auxiliary circuits and more efficiently provide DC electrical power to BEVs.

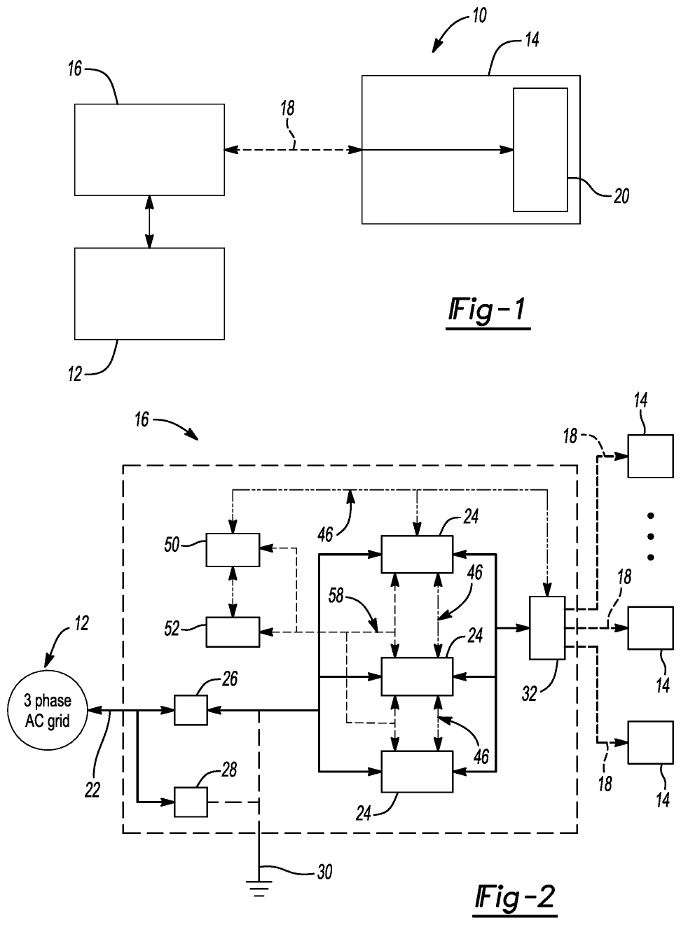

Turning to FIG. 1, an implementation of an electrical system 10 is shown including an electrical grid 12 and a battery electric vehicle (BEV) 14 that can either receive electrical power from or provide electrical power to the grid 12. The electrical grid 12 can include any one of a number of electrical power generators and electrical delivery mechanisms. Electrical generators (not shown) create AC electrical power that can then be transmitted a significant distance away from the electrical generator for residential and commercial use. The electrical generator can couple with the electrical grid 12 that transmits the AC electrical power from the electrical generator to an end user, such as a residence or business. As the AC electrical power is provided to the electrical grid 12, the electrical power can exist at a relatively high voltage so that it can be communicated relatively long distances. Once the electrical power reaches a location where it is intended to be used, electrical transformers (not shown) can be used to reduce the voltage level before ultimately being provided to a residence or business. In one implementation, the voltage level of AC electrical power used is 360-510 volts RMS alternating current three-phase 50-60 Hz. However, this voltage range can be different.

A stationary vehicle charging station, also referred to in this implementation as a DC fast charger 16, can receive AC electrical power from the grid 12, rectify the AC electrical power into DC electrical power, and provide the DC electrical power to the BEV 14. The DC fast charger 16 can be geographically fixed, such as a charging station located in a vehicle garage or in a vehicle parking lot. The DC fast charger 16 can include an input terminal that receives the AC electrical power from the grid 12 and communicates the AC electrical power to a BEV battery 20 directly, bypassing an on-board vehicle battery charger included on the BEV 14. A charging cable 18 can detachably connect with an electrical receptacle on the BEV 14 and electrically link the DC fast charger 16 with the BEV 14 so that DC electrical power can be communicated between the DC fast charger 16 and the BEV battery 20. The DC fast charger 16 can include a plurality of charging cables 18 to charge a plurality of BEVs 14 at the same time. The DC fast charger 16 can receive 480 VAC from the grid 12 and have a power rating of 60-360 kW provided to the BEV 14. This type of DC fast charging may be referred to as Level 3 EV charging. However, the stationary vehicle charging station can be implemented using different standards. The term “battery electric vehicle” or “BEV” can refer to vehicles that are propelled, either wholly or partially, by electric motors. BEV can refer to electric vehicles, plug-in electric vehicles, hybrid-electric vehicles, and battery-powered vehicles. It should be viewed as encompassing passenger vehicles as well as commercial vehicles.

The BEV battery 20 can supply DC electrical power controlled by power electronics to the electric motors that propel the BEV 14. The BEV battery 20 or batteries are rechargeable and can include lead-acid batteries, nickel cadmium (NiCd), nickel metal hydride, lithium-ion, and lithium polymer batteries. A typical range of vehicle battery voltages can range from 100 to 1000V of DC electrical power (VDC). A control system, implemented as computer-readable instructions executable by a microprocessor, can be stored in non-volatile memory and called on to control functionality of the DC fast charger 16. This will be discussed in more detail below.

FIG. 2 depicts an implementation of the DC fast charger 16. The DC fast charger 16 can include a grid input 22 for electrically coupling the DC fast charger 16 to the electrical grid 12, as well as a plurality of charging cables 18 that are configured to detachably couple to BEVs 14. The electrical grid 12 can supply one- or three-phase AC voltage to the DC fast charger 16. The DC fast charger 16 includes electrical components that, collectively, convert the AC voltage received from the grid 12 to DC voltage that can be directly applied to the BEV battery 20. In this implementation, the DC fast charger 16 includes a plurality of enhanced power modules 24 electrically connected to the input 22 in parallel. An electromagnetic (EMI) filter 26 can be electrically connected between the enhanced power modules 24 and the electrical grid 12 to smooth the AC voltage supplied to the modules 24. In some implementations, a surge protective device (SPD) 28 can also be electrically connected between the input 22 and a ground node 30 and used by the DC fast charger 16 to prevent over-voltage events. Each enhanced power module 24 can be electrically connected to an interconnection matrix 32 that is also electrically connected to the charging cables 18 for charging BEVs 14. The interconnection matrix 32 can include a plurality of connectors or switches—at least a pair of switches for each charging cable 18—that can electrically couple or decouple the DC fast charger 16 with the BEV batteries 20 of the BEVs 14, thereby electrically linking the BEV 14 to the charger 16 to selectively provide DC voltage to the BEV battery 20.

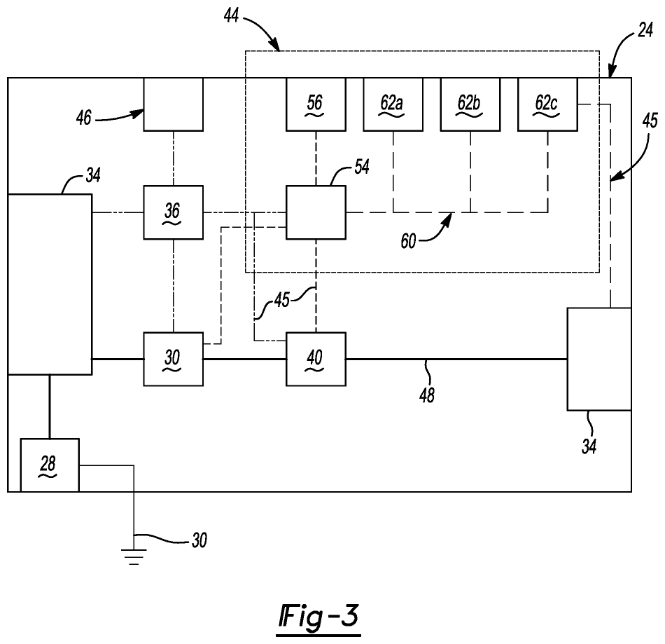

The enhanced power modules 24 include additional functionality beyond the conversion of AC voltage into DC voltage usable by the BEV battery 20. For example, as shown in FIG. 3, each enhanced power module 24 can include electromagnetic compatibility (EMC) filters 34, a switched mode power supply (SMPS) 36, a power factor correction (PFC) module 38, one or more DC-DC converters 40, an isolation monitoring device (IMD) 42, and a control system 44 implemented using one or more microprocessors having programmable memory. Each enhanced power module 24 can receive AC voltage from the grid 12, rectify the received AC voltage using the PFC module 38, and supply the rectified DC voltage to the DC-DC converter 40 as well as the SMPS 36. The DC fast charger 16 can output a DC voltage at a relatively low voltage output 46 using the SMPS 36 for powering the integrated auxiliary circuits as well as at a relatively high DC voltage output 48 from the DC-DC converter 40 for charging the BEV battery 20. It should be appreciated that the SMPS can generate a low voltage output independently from the PFC module 38. For example, the auxiliary circuits receiving DC voltage from the low voltage output 46 can include a user interface (UI) 50 that permits a user of a BEV 14 to initiate and otherwise control the charging of a BEV 14, a cooling system 52 that helps regulate the temperature of the DC fast charger, as well as the control system 44. The low voltage output 46 of one or more enhanced power modules 24 can power the UI 50, the cooling system 52, and the control system 44. The cooling system 52 can include one or more fans powered by DC brushless motors. The SMPS 36 included within the enhanced power modules 24 can also supply a DC voltage to other electrical components through the low voltage output 46. In one implementation, the low voltage output of the enhanced power modules can supply 24 VDC within the DC fast charger 16.

The control system 44 included in the enhanced power modules 24 can have a microprocessor (MCU) 54 with a data input/output (I/O), such as a CAN bus output 56, coupled to a controller area network (CAN) bus 58 within the DC fast charger 16. The control system 44 can have control over the functionality of the SMPS 36 and the PFC module 38 via a control bus 45. The control system 44 can also include an intra-module data bus 60 located within the enhanced power module 24 permitting communication of data between the microprocessor 54 and auxiliary circuit interfaces 62 located within the enhanced power module 24. For example, the control system 44 can include an auxiliary circuit interface 62 for the contactors or switches in the interconnection matrix 62a, the cooling system 62b, and/or the IMD 62c. The auxiliary circuit interface 62 for the IMD 62c can also be coupled to the IMD 42 via the control bus 45 such that the interface 62c can command and control the IMD 42. The auxiliary circuit interfaces 62 may include computer executable instructions accessible by the microprocessor 54 of the control system 44 for providing the functionality of these features of the DC fast charger 16. That is, the control system 44 can generate control commands that enable functionality within the DC fast charger 16, such as the cooling system 52, the IMD 42, and/or the contactors of the inter connection matrix 32.

The control system 44 can be powered using the low voltage output 46 provided by the SMPS 36. The CAN data bus 58 can be coupled, for instance, to the UI 50, the IMD 42, and the cooling system 52 such that the enhanced power modules 24 can at least partially control the operation and/or functionality of these auxiliary circuits. The control system 44 embedded within the enhanced power modules 24 can be implemented using a dedicated microprocessor/microcontroller 54, such as an electronic control unit (ECU), that can access stored executable code and generate computer readable instructions. The MCU 54 can be any type of device capable of processing electronic instructions including microprocessors, microcontrollers, host processors, controllers, vehicle communication processors, and application specific integrated circuits (ASICs). It can be a dedicated processor used only to carry out the described methods or can be shared with other vehicle systems. The MCU 54 can execute various types of digitally-stored instructions, such as software or firmware programs, stored in memory.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A stationary battery charger, configured to detachably couple with and charge a battery electric vehicle (BEV) battery, comprising:
an input for receiving alternating current (AC) voltage from an electrical grid;
one or more electrical cables configured to detachably couple with BEVs; and
one or more enhanced power modules, electrically coupled to the input, that convert AC voltage to direct current (DC) voltage, each comprising a low voltage output for powering auxiliary circuits within the stationary battery charger and a high voltage output for applying DC voltage to the BEV battery.

2. The stationary battery charger recited in claim 1, further comprising one or more auxiliary circuits included with the one or more enhanced power modules.

3. The stationary battery charger recited in claim 2, further comprising an intra-module data bus coupling a control system on the one or more enhanced power modules with the one or more auxiliary circuits.

4. The stationary battery charger recited in claim 2, wherein the auxiliary circuits include a contactor interface, a cooling system interface, or an isolation monitoring device (IMD) interface.

5. The stationary battery charger recited in claim 1, further comprising a controller area network (CAN) bus electrically coupled to the one or more enhanced power modules.

6. The stationary battery charger recited in claim 1, further comprising a DC-DC converter electrically coupled to the one or more enhanced power modules.

7. The stationary battery charger recited in claim 1, further comprising a control bus and a control system, included on the one or more enhanced power modules, capable of transmitting commands to a power factor correction (PFC), a DC-DC converter, an AC-DC power conversion topology, or a switched mode power supply (SMPS).

8. A stationary battery charger, configured to detachably couple with and charge a battery electric vehicle (BEV) battery, comprising:
an input for receiving alternating current (AC) voltage from an electrical grid;
one or more electrical cables configured to detachably couple with BEVs;
one or more enhanced power modules, electrically coupled to the input, that convert AC voltage to direct current (DC) voltage, each comprising:
a switched mode power supply (SMPS) coupled to a low voltage output for powering auxiliary circuits within the stationary battery charger;
a power factor correction (PFC) module that rectifies AC voltage received from the grid into DC voltage supplied to the SMPS and the one or more electrical cables; and
a control system, electrically connected to the SMPS that controls the SMPS and the PFC module.

9. The stationary battery charger recited in claim 8, further comprising one or more auxiliary circuits included with the one or more enhanced power modules.

10. The stationary battery charger recited in claim 9, further comprising an intra-module data bus coupling the control system on the one or more enhanced power modules with the one or more auxiliary circuits.

11. The stationary battery charger recited in claim 9, wherein the auxiliary circuits include a contactor interface, a cooling system interface, or an isolation monitoring device (IMD) interface.

12. The stationary battery charger recited in claim 8, further comprising a controller area network (CAN) bus electrically coupled to the one or more enhanced power modules.

13. The stationary battery charger recited in claim 8, further comprising a DC-DC converter electrically coupled to the one or more enhanced power modules.

14. The stationary battery charger recited in claim 8, further comprising a control bus, included on the one or more enhanced power modules and coupled to the control system, capable of transmitting commands to a power factor correction (PFC), a DC-DC converter, an AC-DC power conversion topology, or a switched mode power supply (SMPS).

15. A stationary battery charger, configured to detachably couple with and charge a battery electric vehicle (BEV) battery, comprising:
an input for receiving alternating current (AC) voltage from an electrical grid;
one or more electrical cables configured to detachably couple with BEVs;
one or more enhanced power modules, electrically coupled to the input, that convert AC voltage to direct current (DC) voltage, each comprising:
a switched mode power supply (SMPS) coupled to a low voltage output for powering auxiliary circuits within the stationary battery charger;
a power factor correction (PFC) module that rectifies AC voltage received from the grid into DC voltage supplied to the SMPS and the one or more electrical cables;
an isolation monitoring device (IMD) electrically coupled to the one or more electrical cables; and
a control system, electrically connected to the SMPS that controls the SMPS, the IMD, and the PFC module.

16. The stationary battery charger recited in claim 15, further comprising one or more auxiliary circuits included with the one or more enhanced power modules.

17. The stationary battery charger recited in claim 16, further comprising an intra-module data bus coupling the control system on the one or more enhanced power modules with the one or more auxiliary circuits.

18. The stationary battery charger recited in claim 15, wherein the auxiliary circuits include a contactor interface, a cooling system interface, or an isolation monitoring device (IMD) interface.

19. The stationary battery charger recited in claim 15, further comprising a controller area network (CAN) bus electrically coupled to the one or more enhanced power modules.

20. The stationary battery charger recited in claim 15, further comprising a DC-DC converter electrically coupled to the one or more enhanced power modules.
